(19) United States
(12) Patent Application Publication
(10) Pub. No.: US 2023/0034798 A1
(43) Pub. Date: Feb. 2, 2023

(54) DISTANCE MEASURING APPARATUS USING SENSOR COVER

(71) Applicant: SAMSUNG ELECTRONICS CO., LTD., Suwon-si (KR)

(72) Inventors: Hyeonghwan CHOI, Suwon-si (KR); Yongkeun JEE, Suwon-si (KR); Jungwon CHOI, Suwon-si (KR)

(73) Assignee: SAMSUNG ELECTRONICS CO., LTD., Suwon-si (KR)

(21) Appl. No.: 17/879,911

(22) Filed: Aug. 3, 2022

Related U.S. Application Data
(63) Continuation of application No. PCT/KR2022/010699, filed on Jul. 21, 2022.

(30) Foreign Application Priority Data
Jul. 30, 2021 (KR) 10-2021-0100680

(51) Int. Cl. G01S 17/08; G01S 17/88; G01S 7/481

(52) U.S. Cl. CPC G01S 17/08; G01S 17/88; G01S 7/4813; G01S 7/4816

(57) ABSTRACT

A refrigerator including a body including at least one door and at least one distance measuring apparatus attachable to the body is provided. The at least one distance measuring apparatus includes: a distance sensor including a light emitting unit and a light receiving unit, the light emitting unit being configured to irradiate light along a first field of view (FoV), and the light receiving unit being configured to receive light incident on a second FoV; and a sensor cover including a light receiving opening portion, the light receiving opening portion being provided to pass a portion of light incident on the second FoV and block a remaining portion of the light incident on the second FoV.

### CROSS-REFERENCE TO RELATED APPLICATION

This application is a continuation application, under 35 U.S.C. § 111(a), of international application No. PCT/KR2022/010699, filed on Jul. 21, 2022, which is claims priority under 35 U. S. C. § 119 to Korean Patent Application No. 10-2021-0100680, filed on Jul. 30, 2021, the disclosures of which are incorporated herein by reference in their entirety.

### BACKGROUND

### Field

The disclosure relates to a distance measuring apparatus which includes use of a sensor cover.

### Description of Related Art

Technologies for detecting an approach of a person by using a distance sensor and performing an operation accordingly have been developed for electric/electronic apparatuses (hereinafter, referred to as “electronic apparatuses”) such as refrigerators, dishwashers, rice cookers, microwave ovens, ovens, induction heaters, washing machines, dryers, and clothes purifiers. Accordingly, there is a demand for a technique for measuring a distance to a target object such as a human body.

### SUMMARY

According to an embodiment of the disclosure, a refrigerator includes a body and at least one distance measuring apparatus attachable to the body, wherein the body includes at least one door at a front of the refrigerator, and the at least one distance measuring apparatus includes a distance sensor including a light emitting unit and a light receiving unit, the light emitting unit being configured to irradiate light along a first field of view (FoV), and the light receiving unit being configured to receive light incident on a second FoV, and a sensor cover including a light receiving opening portion, the light receiving opening portion being provided to pass a portion of light incident on the second FoV and block a remaining portion of the light incident on the second FoV.

The light receiving opening portion may be provided to block light reflected by the body and incident from among the light incident on the second FoV.

The light receiving opening portion may be provided to block light reflected by a floor where the refrigerator is placed and incident on the second FoV.

The at least one distance measuring apparatus may be arranged along a first direction of the first door, at a rear of a front surface of the at least one door, the first direction may be perpendicular to the front of the refrigerator, the light receiving opening portion may be provided to pass light with an incident angle along a second direction opposite to the first direction that is less than a first blocking angle and block light with an incident angle along the second direction that is equal to or greater than the first blocking angle, and the first blocking angle may be less than an incident angle along the second direction of light reflected by a surface of the at least one door along the first direction and directed toward the light receiving unit.

The at least one distance measuring apparatus may be attached to a side of the at least one door along the first direction, and the first direction may include a direction from a center of the at least one door toward a handle of the at least one door.

The at least one door may be a first door and the refrigerator further includes a second door arranged along the first direction of the first door, the at least one distance measuring apparatus may be arranged between the first door and the second door, at a rear of a front surface of the second door, the light receiving opening portion may be provided to pass light with an incident angle along the first direction that is less than a second blocking angle and block light with an incident angle along the first direction that is equal to or greater than the second blocking angle, and the second blocking angle may be less than an incident angle along the first direction of light reflected by a surface along the second direction of the second door and directed toward the light receiving unit.

The first direction may be along a downward direction of the refrigerator, the at least one door may be arranged so that a lower surface of the at least one door is adjacent to a floor on which the refrigerator is placed, the light receiving opening portion may be provided to pass light with an incident angle along the downward direction that is less than a third blocking angle and block light with an incident angle along the downward direction that is equal to or greater than the third blocking angle, and an incident angle along the downward direction of light reflected by the floor and directed toward the light receiving unit may be greater than the third blocking angle.

The at least one distance measuring apparatus may be arranged adjacent to a floor on which the refrigerator is placed, the light receiving opening portion may be provided to pass light with an incident angle along a downward direction that is less than a third blocking angle and block light with an incident angle along the downward direction that is equal to or greater than the third blocking angle, and the third blocking angle may be less than an incident angle along the downward direction of light reflected by the floor and directed toward the light receiving unit.

The sensor cover may include a light emitting opening portion configured to pass a portion of light irradiated from the light emitting unit to the first FoV and block a remaining portion of light irradiated from the light emitting unit to the first FoV.

The sensor cover may be configured such that a portion of the sensor cover is adjacent one surface of the distance sensor so that the light irradiated from the light emitting unit to the first FoV is not incident on the light receiving unit by being reflected by the sensor cover.

The light emitting opening portion may be provided to block light irradiated toward the body or a floor on which the refrigerator is placed from among the light irradiated to the first FoV.

A width of the light emitting opening portion along a first direction may be greater than a width of the light receiving opening portion along the first direction, where the first direction may be perpendicular to the front of the refrigerator.

The light receiving opening portion may be provided to pass light with an incident angle along a first direction that is less than a first blocking angle and block light with an incident angle along the first direction that is greater than the first blocking angle, the first direction may be perpendicular to the front of the refrigerator, the light emitting opening portion may be provided to pass light with an irradiation angle along the first direction that is less than a second blocking angle and block light with an irradiation angle along the first direction that is equal to or greater than the second blocking angle, and the second blocking angle may be greater than the first blocking angle.

The at least one distance measuring apparatus may be among a plurality of distance measuring apparatuses, a light receiving opening portion of each of the plurality of distance measuring apparatuses may be provided to pass light with an incident angle along a first direction that is less than a first blocking angle and block light with an incident angle along the first direction that is equal to or greater than the first blocking angle, the plurality of distance measuring apparatuses may be arranged along a second direction perpendicular to the first direction, and may be arranged to have a certain angular difference so that detection areas of the plurality of distance measuring apparatuses are radially widened without overlapping each other along the second direction, and the first direction and the second direction may be perpendicular to the front of the refrigerator.

The at least one distance measuring apparatus may be among a plurality of distance measuring apparatuses, a light receiving opening portion of each of the plurality of distance measuring apparatuses may be provided to pass light with an incident angle along a first direction that is less than a first blocking angle and block light with an incident angle along the first direction that is equal to or greater than the first blocking angle, the refrigerator may include a first distance measuring module and a second distance measuring module, the first distance measuring module including two or more of the plurality of distance measuring apparatuses, and the second distance measuring module including other two or more of the plurality of distance measuring apparatuses.

The two or more of the plurality of distance measuring apparatuses included in the first distance measuring module may be arranged along a second direction perpendicular to the first direction, and may be arranged to have a certain angular difference so that detection areas are radially widened without overlapping each other along the second direction, the other distance other two or more of the plurality of distance measuring apparatuses included in the second distance measuring module may be arranged along the second direction, and may be arranged to have a certain angular difference so that detection areas are radially widened without overlapping each other along the second direction, the second distance measuring module may be arranged along the second direction of the first distance measuring module to be apart from the first distance measuring module along the second direction, and the first direction and the second direction may be perpendicular to the front of the refrigerator.

According to an embodiment of the disclosure, a distance measuring apparatus includes a distance sensor including a light emitting unit and a light receiving unit, the light emitting unit being configured to irradiate light along a first field of view (FoV), and the light receiving unit being configured to receive light incident on a second FoV, and a sensor cover including a light receiving opening portion, the light receiving opening portion being provided to pass a portion of light incident on the second FoV and block a remaining portion of the light incident on the second FoV.

The sensor cover may include a light emitting opening portion provided to pass the portion of light irradiated from the light emitting unit and block the remaining portion of the light irradiated from the light emitting unit.

The sensor cover may be configured such that a portion of the sensor cover contacts one surface of the distance sensor so that light irradiated to the first FoV is not incident on the light receiving unit by being reflected by the sensor cover.

A width of the light emitting opening portion along a first direction may be greater than a width of the light receiving opening portion along the first direction, and the first direction may be perpendicular to a front of the distance measuring apparatus.

The light receiving opening portion may be provided to pass light with an incident angle along a first direction that is less than a first blocking angle and block light with an incident angle along the first direction that is equal to or greater than the first blocking angle, the light emitting opening portion may be provided to pass light with an irradiation angle along the first direction that is less than a second blocking angle and block light with an irradiation angle along the first direction that is equal to or greater than the second blocking angle, the first direction may be perpendicular to a front of the distance measuring apparatus, and the second blocking angle may be greater than the first blocking angle.

According to an embodiment of the disclosure, an electronic apparatus includes a memory to store one or more instructions, a processor configured to execute the one or more instructions, a body, and at least one distance measuring apparatus attachable to the body, wherein the at least one distance measuring apparatus includes a distance sensor including a light emitting unit and a light receiving unit, the light emitting unit being configured to irradiate light along a first field of view (FoV), and the light receiving unit being configured to receive light incident to a second FoV, and a sensor cover including a light receiving opening portion, the light receiving opening portion being provided to pass a portion of light incident on the second FoV and block a remaining portion of the light incident on the second FoV.

### BRIEF DESCRIPTION OF DRAWINGS

FIG. 1 is a diagram illustrating an example of an operation of a distance sensor according to an embodiment of the disclosure.

FIG. 2 is a diagram schematically illustrating a configuration of a distance measuring apparatus according to an embodiment of the disclosure.

FIG. 3 is a diagram schematically illustrating a configuration of a distance measuring apparatus according to another embodiment of the disclosure.

FIG. 4 is a diagram illustrating a change in field of view (FoV) according to the shape of the slit in a distance measuring apparatus according to an embodiment of the disclosure.

FIG. 5A is a side view of a refrigerator including a distance measuring apparatus, according to an embodiment of the disclosure.

FIG. 5B is a side view of a refrigerator including a distance measuring apparatus, according to an embodiment of the disclosure.

FIG. 5C is a front view and a plan view of a refrigerator including a distance measuring apparatus, according to an embodiment of the disclosure.

FIG. 5D is a front view, a side view, and a plan view of a refrigerator including a distance measuring apparatus, according to an embodiment of the disclosure.

FIG. 6 is an experiment result of the performances of distance measuring apparatuses according to embodiments of the disclosure.

FIG. 7 is a diagram schematically illustrating a configuration of a distance measuring apparatus according to an embodiment of the disclosure.

FIG. 8 is a diagram illustrating a distance measuring module including a plurality of distance measuring apparatuses and a detection area thereof, according to an embodiment of the disclosure.

FIG. 9 is a diagram illustrating a refrigerator including a plurality of distance measuring modules and detection areas thereof, according to an embodiment of the disclosure.

FIG. 10 is a block diagram of a configuration of an electronic apparatus according to an embodiment of the disclosure.

### DETAILED DESCRIPTION OF EXEMPLARY EMBODIMENTS

Throughout the disclosure, the expression “at least one of a, b or c” indicates only a, only b, only c, both a and b, both a and c, both b and c, all of a, b, and c, or variations thereof.

The disclosure will now be described more fully with reference to the accompanying drawings, in which embodiments of the disclosure are shown. In the description of the disclosure, certain detailed explanations of related well-known functions or elements are omitted when it is deemed that they may unnecessarily obscure the essence of the disclosure. In the drawings, elements having substantially the same functions or configurations are denoted by the same reference numerals or symbols. An apparatus and method will be described together when necessary for convenience of explanation. Operations of the disclosure need not necessarily be performed in the described order, and may be performed in parallel, selectively, or individually.

According to an embodiment of the disclosure, provided is a distance measuring apparatus including a sensor cover having a slit so that a detection range may be effectively set.

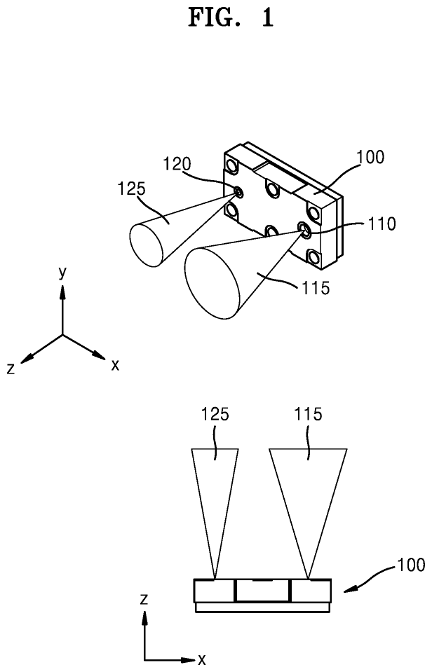

FIG. 1 is an example diagram illustrating an operation of a distance sensor 100 according to an embodiment of the disclosure. Referring to FIG. 1, the distance sensor 100 according to an embodiment of the disclosure may include a light emitting unit 110 configured to irradiate light and a light receiving unit 120 configured to receive light. The light emitting unit 110 may irradiate light at a certain field of view (FoV), and the light receiving unit 120 may receive light incident to a certain FoV. In the example of FIG. 1, in a FoV 115 of the light emitting unit 110, a center of the light emitting unit 110 is a vertex thereof, and an angle from the center of the light emitting unit 110 to a straight line directed toward a measurement direction of the distance sensor 100 (a z direction, hereinafter, referred to as “a front of the distance sensor 100) is within a range of 35 degrees. In other words, the straight line directed toward the measurement direction of the distance sensor 100 may be a normal line with respect to a front surface (an x-y plane) of the distance sensor 100, the normal line passing through the center of the light emitting unit 110. Hereinafter, the “normal line” may refer to a normal line with respect to the front surface of the distance sensor 100, that is, the straight line directed toward the measurement direction of the distance sensor 100. In the example of FIG. 1, a FoV 125 of the light receiving unit 120 may be in a range of about 25 degrees with respect to a normal line passing through a center of the light receiving unit 120. Throughout the disclosure, an x direction, a y direction, and a z direction may be perpendicular to each other.

Light irradiated from the light emitting unit 110 to the front of the distance sensor 100 may be reflected by a target object and incident on the light receiving unit 120, and the light receiving unit 120 may receive the incident reflected light, and may calculate a distance to the target object based on the received reflected light. A detection area in which the distance sensor 100 may detect a target object may be determined by the FoV 115 of the light emitting unit 110 and the FoV 125 of the light receiving unit 120, and may be generally determined similarly to the FoV 125 of the light receiving unit 120. For example, the detection area of the distance sensor 100 may be in a range of about 25 degrees with respect to the normal line passing through the center of the light receiving unit 120. Generally, a maximum distance (e.g., 60 cm, 200 cm, 400 cm, 800 cm) that may be detected by the distance sensor 100 may be determined.

The distance sensor 100 including the light emitting unit 110 and the light receiving unit 120 may be configured in a shape different from that shown in FIG. 1. Hereinafter, for convenience, the distance sensor 100 having the shape shown in FIG. 1 is mainly described. The distance sensor 100 may include a distance sensor of a time of flight (ToF) type.

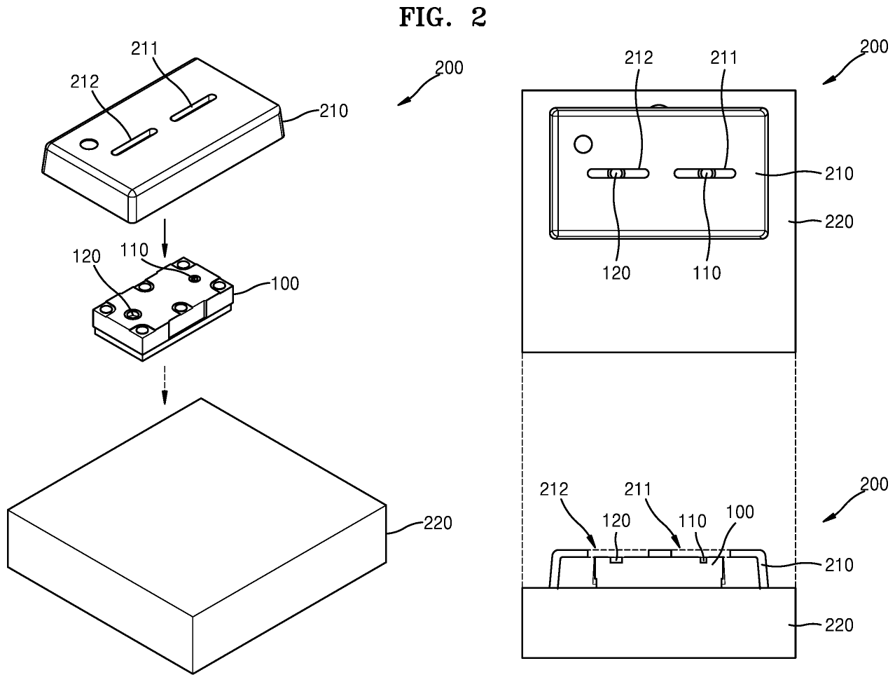

FIG. 2 is a diagram schematically illustrating a configuration of a distance measuring apparatus 200 according to an embodiment of the disclosure. Referring to FIG. 2, the distance measuring apparatus 200 according to an embodiment of the disclosure may include a distance sensor 100 and a sensor cover 210. The distance measuring apparatus 200 may further include a printed circuit board (PCB) 220. The distance sensor 100 may be fixed to the PCB 220, and the sensor cover 210 may be fixed to the distance sensor 100 or the PCB 220.

The sensor cover 210 may include a light emitting opening portion 211 through which light irradiated from the light emitting unit 110 passes, and a light receiving opening portion 212 through which light incident on the light receiving unit 120 passes. The light emitting opening portion 211 may be provided to block a portion of light irradiated from the light emitting unit 110. In other words, the light emitting opening portion 211 may be provided to pass a portion of the light irradiated from the light emitting unit 110 and block a remaining portion of the light irradiated from the light emitting unit 110. The light receiving opening portion 212 may be provided to block a portion of light incident to the FoV 125 of the light receiving unit 120. In other words, the light receiving opening portion 212 may be provided to pass a portion of the light incident to the FoV 125 of the light receiving unit 120 and block a remaining portion of the light incident to the FoV 125 of the light receiving unit 120.

The light receiving opening portion 212 may be provided to pass light incident in a partial angular range of the FoV 125 of the light receiving unit 120 and block light incident in a remaining angular range of the FoV 125 of the light receiving unit 120. The light receiving opening portion 212 may be provided to pass light incident on the light receiving unit 120 at an angle less than a first blocking angle and block light incident on the light receiving unit 120 at an angle equal to or greater than the first block angle. Here, the angle at which the light is incident may refer to an angle with respect to the normal line passing through the center of the light receiving unit 120. Hereinafter, the angle is referred to as an “incident angle”.

The light emitting opening portion 211 may be provided to pass light irradiated in a certain angular range of a FoV 115 of the light emitting unit 110 and block light irradiated in a remaining angular range of the FoV 115 of the light emitting unit 110. The light emitting opening portion 211 may be provided to pass light irradiated at an angle less than a second blocking angle from the light emitting unit 110 and block light irradiated at an angle equal to or greater than the second blocking angle from the light emitting unit 110. Here, the angle at which the light is irradiated may refer to an angle with respect to a normal line passing through the center of the light emitting unit 110. Here, the angle is referred to as an “irradiation angle”. Here, the second blocking angle may be the same as or different from the first blocking angle. The second blocking angle may be greater than the first blocking angle.

In order to prevent light irradiated from the light emitting unit 110 from being reflected by an inner surface of the sensor cover 210 and incident on the light receiving unit 120, the sensor cover 210 may be disposed adjacent to the front surface of the distance sensor 100, as shown in FIG. 2.

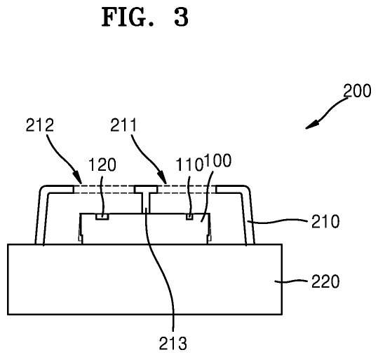

FIG. 3 is a diagram schematically illustrating a configuration of a distance measuring apparatus 200 according to an embodiment of the disclosure. In FIG. 2 described above, one surface of the inner surface of the sensor cover 210 is adjacent to the front surface of the distance sensor 100 as a whole. However, as shown in FIG. 3, a portion 213 of the sensor cover 210 may be adjacent to a portion between the light emitting unit 110 and the light receiving unit 120 of the distance sensor 100, so that light irradiated from the light emitting unit 110 may be prevented from being reflected by the inner surface of the sensor cover 210 and incident on the light receiving unit 120. In an embodiment of the disclosure, the distance measuring apparatus 200 may be configurated such that the portion 213 of the sensor cover 210 may be adjacent to one surface of the distance sensor 100, and then light irradiated from the light emitting unit 110 to the FoV 115 of the light emitting unit 110 is not incident on the light receiving unit 120 by being reflected by the sensor cover 210.

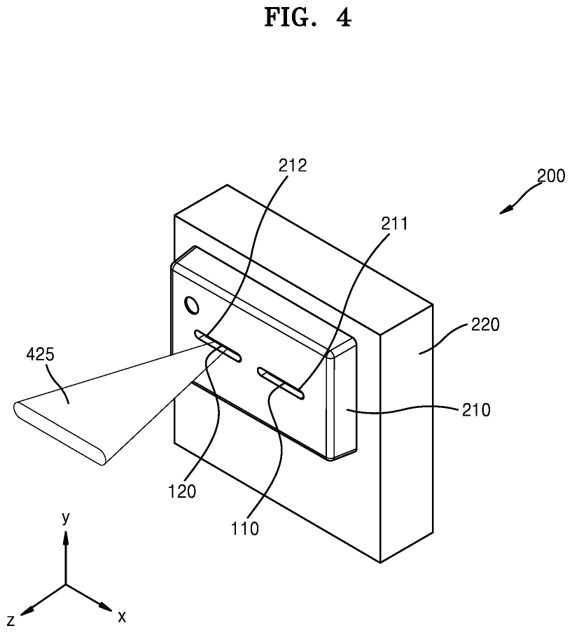

FIG. 4 is a diagram illustrating a change in FoV of a distance measuring apparatus 200 according to the shape of the slit, according to an embodiment of the disclosure. Referring to FIG. 4, the light receiving opening portion 212 of the distance measuring apparatus 200 according to an embodiment of the disclosure may be provided in a horizontally long and vertically short shape, and thus, compared to the FoV 125 of the light receiving unit 212 described above, in a FoV 425 of the light receiving unit 212 limited by the sensor cover 210, there is little change in a horizontal width and a vertical width is greatly reduced. Accordingly, the detection area of the distance sensor 100 may also change similarly. For example, the detection area of the distance sensor 100 may be in a range of about 25 degrees horizontally and about 5 degrees vertically with respect to the normal line passing through the center of the light receiving unit 120. In FIG. 4, the y direction is an upward direction of the distance measuring apparatus 200, and the opposite direction is a downward direction of the distance measuring apparatus 200. In addition, the x direction is a left direction of the distance measuring apparatus 200, and the opposite direction of the x direction is a right direction of the distance measuring apparatus 200. The z direction is a front direction of the distance measuring apparatus 200.

In an embodiment of the disclosure, the light receiving opening portion 212 may be provided to pass light incident in a partial angular range of the FoV of the light receiving unit 120 in the y direction (upward direction) and block light incident in a remaining angular range of the FoV of the light receiving unit 120 in the y direction.

In an embodiment of the disclosure, the light receiving opening portion 212 may be provided to pass light having an incident angle in the y direction (upward direction) that is less than the first blocking angle and block light having an incident angle in the y direction that is equal to or greater than the first blocking angle.

In an embodiment of the disclosure, with respect to light having an incident angle in the x direction (left direction) of 0 degrees, the light receiving opening portion 212 may be provided to pass light incident in a partial angular range of the FoV of the light receiving unit 120 in the y direction (upward direction) and block light incident in a remaining angular range of the FoV of the light receiving unit 120 in the y direction, and may be provided to pass, as it is, light having an incident angle in the y direction of 0 degrees and incident to the FoV of the light receiving unit 120 in the x direction.

In an embodiment of the disclosure, the light receiving opening portion 212 may be provided to pass light having an incident angle in the x direction (left direction) of about 0 degrees and having an incident angle in the y direction (upward direction) that is less than the first blocking angle and block light having an incident angle in the x direction of 0 degrees and having an incident angle in the y direction that is equal to or greater than the first blocking angle, and may be provided to pass, as it is, light having an incident angle in the y direction of 0 degrees and incident to the FoV of the light receiving unit 120 in the x direction. In this case, a FoV angle in the upward direction may decrease, and a FoV angle in the left direction may remain the same. However, in reality, the FoV angle in the left direction may change slightly due to various non-ideal effects. As the FoV of the light receiving unit 120 changes as described above, the detection area of the distance sensor 100 may also decrease in the upward direction and remain almost the same in the left direction. The light receiving opening portion 212 may block light symmetrically in an opposite direction (the −y direction) of the y direction, that is, a downward direction, in the same manner as in the upward direction, or may block light asymmetrically in a different manner from the upward direction. For example, the light receiving opening portion 212 may be provided that the FoV of the light receiving unit 120 may be about 2.5 degrees both upward direction and downward direction. For example, the light receiving opening portion 212 may be provided that the FoV of the light receiving unit 120 may be about 2.5 degrees in the upward direction and about 0 degrees in the downward direction. With respect to the opposite direction (the −x direction) of the x direction, that is, the right direction, the light receiving opening portion 212 may be provided in the same manner.

In an embodiment of the disclosure, the light emitting opening portion 211 may be provided to pass light irradiated in a partial angular range of the FoV of the light emitting unit 110 in the y direction and block light irradiated in a remaining angular range of the FoV of the light emitting unit 110 in the y direction.

In an embodiment of the disclosure, the light emitting opening portion 211 may be provided to pass light having an irradiation angle in the y direction that is less than the second blocking angle and block light having an irradiation angle in the y direction that is equal to or greater than the second blocking angle.

In an embodiment of the disclosure, with respect to light having an irradiation angle in the x direction that is 0 degrees, the light emitting opening portion 211 may be provided to pass light irradiated in a partial angular range of the FoV of the light emitting unit 110 in the y direction and block light irradiated in a remaining angular range of the FoV of the light emitting unit 110 in the y direction, and may be provided to pass, as it is, light having an irradiation angle in the y direction of about 0 degrees and irradiated to the FoV of the light emitting unit 110 in the x direction.

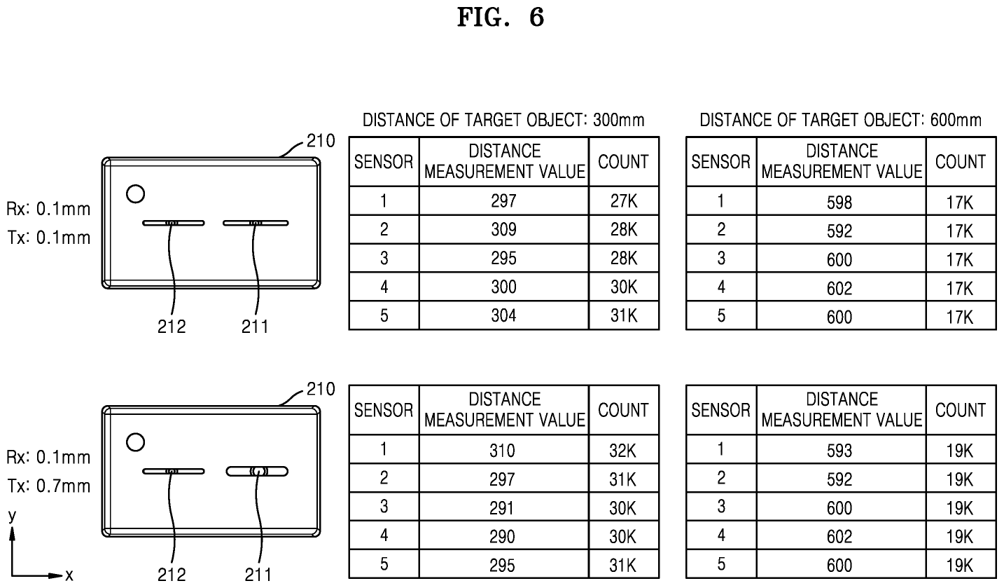

In an embodiment of the disclosure, the light emitting opening portion 211 may be provided to pass light having an irradiation angle in the x direction of about 0 degrees and having an irradiation angle in the y direction that is less than the second blocking angle and block light having an irradiation angle in the x direction of about 0 degrees and having an irradiation angle in the y direction that is equal to or greater than the second blocking angle, and may be provided to pass, as it is, light having an irradiation angle in the y direction of 0 degrees and incident to the FoV of the light emitting unit 110 in the x direction. Here, the second blocking angle may be the same as or different from the first blocking angle. The second blocking angle is preferably greater than the first blocking angle, and this is described later with reference to FIG. 6. The light emitting opening portion 211 may symmetrically block light in the x direction or an opposite direction of the y direction, or may asymmetrically block light.

According to embodiments, the light receiving opening portion 212 or the light emitting opening portion 211 may be provided in different shapes. For example, the light receiving opening portion 212 or the light emitting opening portion 211 may be provided in a horizontally short and vertically long shape.

Meanwhile, the FoV of the light receiving unit 120 or the light emitting unit 110 may be adjusted by adjusting a thickness of the sensor cover 210 or a distance between the sensor cover 210 and the distance sensor 100. When a manufacturing process makes it difficult to reduce a width of a slit as necessary to reduce the FoV, the thickness of the sensor cover 210 or the distance between the sensor cover 210 and the distance sensor 100 may be increased to reduce the FoV of the light receiving unit 120 or the light emitting unit 110.

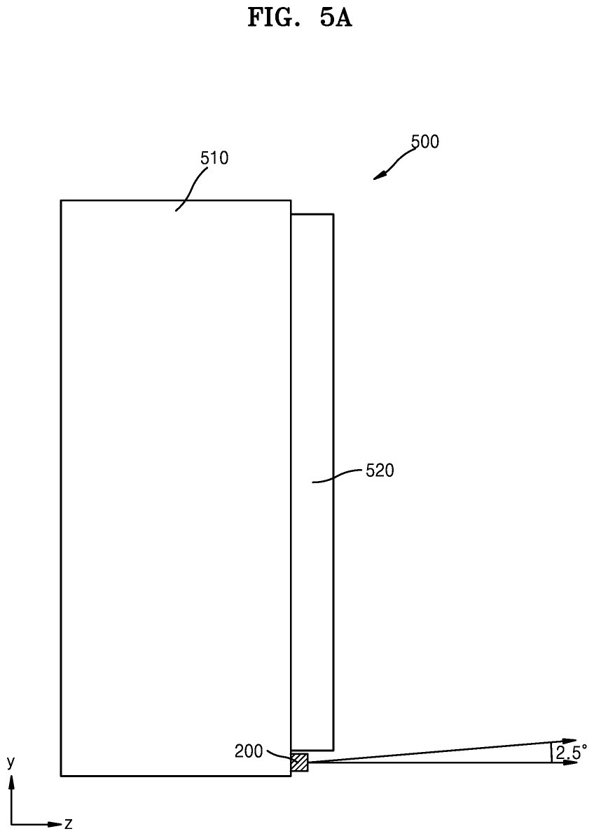

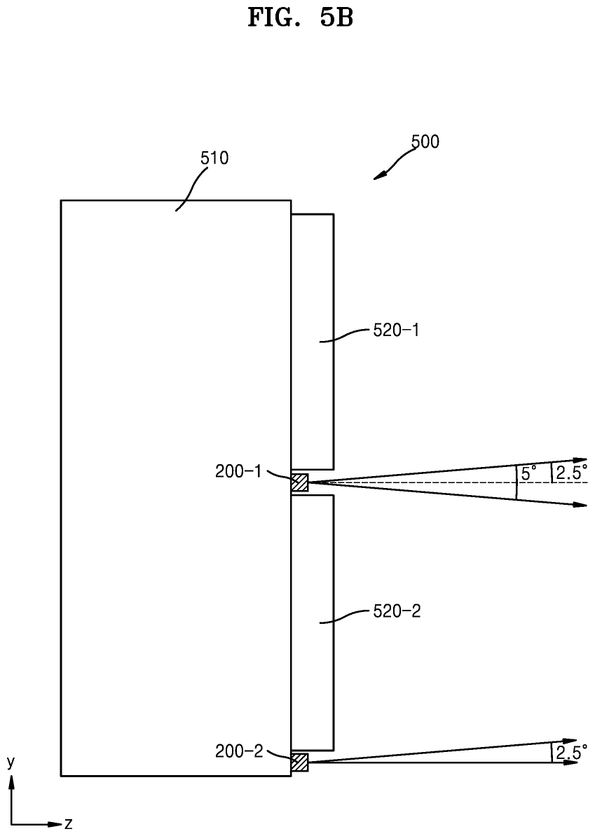

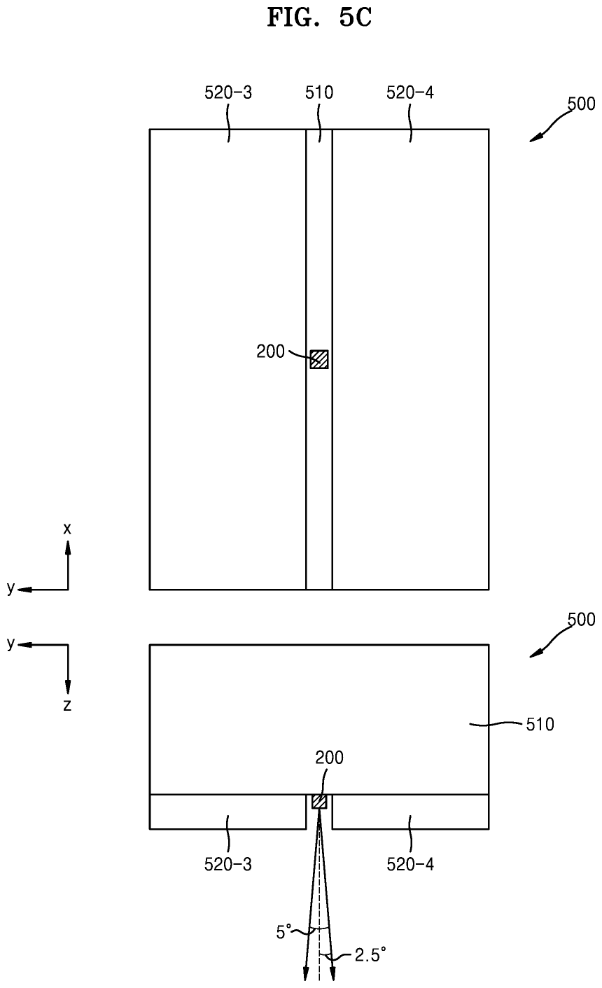

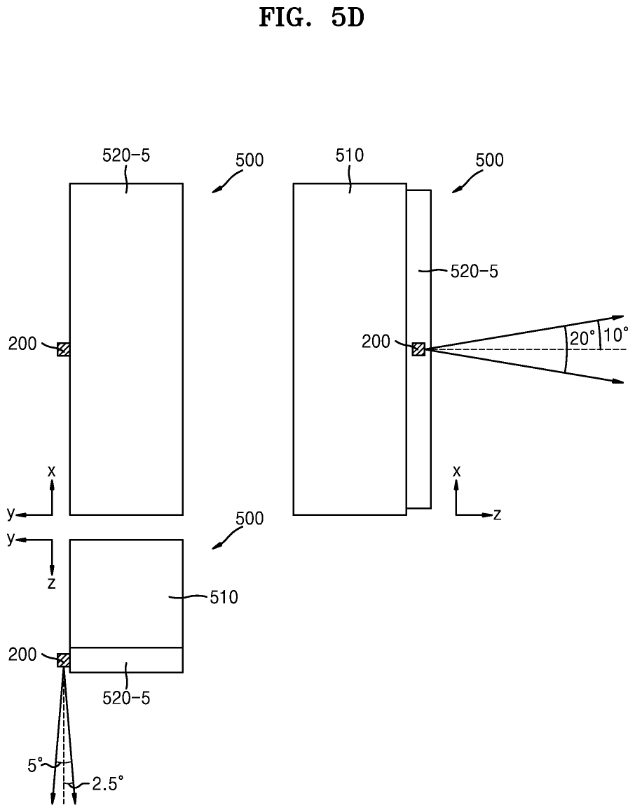

FIG. 5A is a side view of a refrigerator 500 including a distance measuring apparatus 200 according to an embodiment of the disclosure. Referring to FIG. 5A, the refrigerator 500 may include a body 510 and the distance measuring apparatus 200, the body including a main body 510 and a door 520. The door 520 may be a rotary door. In FIG. 5A, the z direction is a front direction of the refrigerator 500, and the y direction is an upward direction of the refrigerator 500. Although not shown, the x direction is a left direction of the refrigerator 500. The distance measuring apparatus 200 may be arranged below (the −y direction) the door 520. In particular, because the distance measuring apparatus 200 is arranged adjacent to the floor on which the refrigerator 500 is placed, a foot of a person approaching the refrigerator 500 may be easily detected. Here, the “floor on which the refrigerator is placed” may refer to the floor on which the refrigerator is placed, assuming that the refrigerator is placed upright. The distance measuring apparatus 200 may be arranged at a rear side (the −z direction) opposite to the front (the z direction) side of the door 520.

As described above, when the distance measuring apparatus 200 is arranged at the rear side (the −z direction) of the door 520, below the door 520, in order to prevent light reflected by a lower surface of the door 520 from being incident on the light receiving unit 120 of the distance measuring apparatus 200, the light receiving opening portion 212 of the sensor cover 210 may be provided so that the FoV of the light receiving unit 120 is limited to a certain range. In an embodiment of the disclosure, the light receiving opening portion 212 may be provided to pass light having an incident angle in the upward direction (the y direction) that is less than the first blocking angle and block light having an incident angle in the upward direction that is equal to or greater than the first blocking angle. In this case, by setting the first blocking angle so that an incident angle in the upward direction (the y direction) of light reflected by the lower surface of the door 520 and directed toward the light receiving unit 120 is greater than the first blocking angle, the light reflected by the lower surface of the door 520 toward the light receiving unit 120 of the distance measuring apparatus 200 may be blocked. For example, the FoV of the light receiving unit 120 may be limited to about 2.5 degrees in the upward direction, as shown in FIG. 5A. Here, the light directed toward the light receiving unit 120 may come within a measurement range of the distance measuring apparatus 200, and the same may be applied to the description below. Light having an incident angle in the upward direction that is less than the first blocking angle may not be blocked regardless of an incident angle in the horizontal direction (the x direction or the −x direction).

In addition, in order to prevent a portion of the light irradiated from the light emitting unit 110 of the distance measuring apparatus 200 to the FoV of the light emitting unit 110 from being reflected by the lower surface of the door 520, the light emitting opening portion 211 of the sensor cover 210 may be provided that the FoV of the light emitting unit 110 may be limited to a certain range. In an embodiment of the disclosure, the light emitting opening portion 211 may be provided to pass light having an irradiation angle in the upward direction (the y direction) that is less than the second blocking angle and block light having an irradiation angle in the upward direction that is equal to or greater than the second blocking angle. In this case, the second blocking angle may be set such that an irradiation angle in the upward direction (the y direction) of light irradiated toward the lower surface of the door 520 from among light irradiated to the FoV of the light emitting unit 110 from the light emitting unit 110 is greater than the second blocking angle. Light having an irradiation angle in the upward direction that is less than the first blocking angle may not be blocked regardless of an irradiation angle in the horizontal direction (the x direction or the −x direction). Here, the second blocking angle may be the same as or different from the first blocking angle. The second blocking angle is preferably greater than the first blocking angle, and this is described later with reference to FIG. 6.

Meanwhile, when the distance measuring apparatus 200 is arranged adjacent to a floor on which the refrigerator 500 is placed, in order to prevent light reflected by the floor from being incident on the light receiving unit 120 of the distance measuring apparatus 200, the light receiving opening portion 212 of the sensor cover 210 may be provided such that the FoV of the light receiving unit 120 is limited to a certain range. In an embodiment of the disclosure, the light receiving opening portion 212 may be provided to pass light having an incident angle in the downward direction (the −y direction) that is less than a third blocking angle and block light having an incident angle in the downward direction that is equal to or greater than the third blocking angle. In this case, the third blocking angle may be set such that an incident angle in the downward direction (the −y direction) of light reflected by the floor and directed toward the light receiving unit 120 is greater than the third blocking angle. For example, the FoV of the light receiving unit 120 may be limited to 0 degrees in the downward direction, as shown in FIG. 5A. The FoV of the light receiving unit 120 may not be limited in the horizontal direction.

In addition, in order to prevent a portion of light irradiated to the FoV of the light emitting unit 110 of the distance measuring apparatus 200 from being reflected by the floor where the refrigerator 500 is placed, the light emitting opening portion 211 of the sensor cover 210 may be provided so that the FoV of the light emitting unit 110 is limited to a certain range. In an embodiment of the disclosure, the light emitting opening portion 211 may be provided to pass light having an irradiation angle in the downward direction (the −y direction) that is less than a fourth blocking angle and block light having an irradiation angle in the downward direction that is equal to or greater than the fourth blocking angle is blocked. In this case, the fourth blocking angle may be set such that an irradiation angle in the downward direction (the −y direction) of light irradiated toward the floor from among light irradiated to the FoV of the light emitting unit 110 from the light emitting unit 110 is greater than the fourth blocking angle. Here, the light irradiated toward the floor may include light irradiated toward the floor within the measurement range of the distance measuring apparatus 200. The FoV of the light emitting unit 110 may not be limited in the horizontal direction. The fourth blocking angle may be greater than the third blocking angle.

FIG. 5B is a side view of the refrigerator 500 including first and second distance measuring apparatuses 200-1 and 200-2 according to an embodiment of the disclosure. In FIG. 5B, the z direction is the front direction of the refrigerator 500, and the y direction is the upward direction of the refrigerator 500. Although not shown, the x direction is the left direction of the refrigerator 500. Referring to FIG. 5B, a body 510 of the refrigerator 500 may include an upper door 520-1 and a lower door 520-2, and the first distance measuring apparatus 200-1 may be arranged between the upper door 520-1 and the lower door 520-2. The upper door 520-1 and the lower door 520-2 may be rotary doors. In particular, the first distance measuring apparatus 200-1 may be arranged in the vicinity of a door handle to easily detect a hand of a person that approaches the door handle to open the door. The first distance measuring apparatus 200-1 may be arranged at the same position in the x direction of the refrigerator 500 as the door handle. The first distance measuring apparatus 200-1 may be arranged at a position overlapping the door handle in the x direction of the refrigerator 500. The first distance measuring apparatus 200-1 may be arranged at a position adjacent to the door handle in the x direction of the refrigerator 500. The first distance measuring apparatus 200-1 may be arranged at a rear (the −z direction), relative to the front (the z direction) surface, of the upper door 520-1 or the lower door 520-2.

When the distance measuring apparatus 200 is arranged between doors of the refrigerator 500 as described above, in order to prevent light reflected by a lower surface of the upper door 520-1 or an upper surface of the lower door 520-2 from being incident on a light receiving unit of the first distance measuring apparatus 200-1, a light receiving opening portion of a sensor cover may be provided so that a FoV of the light receiving unit is limited to a certain range. In an embodiment of the disclosure, the light receiving opening portion of the first distance measuring apparatus 200-1 may be provided to pass light having an incident angle in the upward direction (the y direction) that is less than the first blocking angle, block light having an incident angle in the upward direction that is equal to or greater than the first blocking angle, pass light having an incident angle in the downward direction (the −y direction) that is less than the second blocking angle, and block an incident angle in the downward direction that is equal to or greater than the second blocking angle. In this case, the first blocking angle may be set so that an incident angle in the upward direction (the y direction) of light reflected by the lower surface of the upper door 520-1 and directed toward the light receiving unit is greater than the first blocking angle, and the second blocking angle may be set an incident angle in the downward direction (the −y direction) of light reflected by the upper surface of the lower door 520-2 and directed toward the light receiving unit is greater than the second blocking angle. For example, the FoV of the light receiving unit may be limited to about 2.5 degrees upward and about 2.5 degrees downward, as shown in FIG. 5B. Light having an incident angle between the first blocking angle in the upward direction and the second blocking angle in the downward direction may not be blocked regardless of an incident angle in the horizontal direction (the x direction or the −x direction).

In addition, in order to prevent a portion of light irradiated to the FoV of the light emitting unit of the first distance measuring apparatus 200-1 from being reflected by the lower surface of the upper door 520-1 or the upper surface of the lower door 520-2, a light emitting opening portion of the sensor cover may be provided so that the FoV of the light emitting unit is limited to a certain range. In an embodiment of the disclosure, the light emitting opening portion of the first distance measuring apparatus 200-1 may be provided to pass light having an irradiation angle in the upward direction (the y direction) that is less than the third blocking angle, block light having an incident angle in the upward direction that is equal to or greater than the third blocking angle, pass light having an irradiation angle in the downward direction (the −y direction) that is less than the fourth blocking angle, and block an incident angle in the downward direction that is equal to or greater than the fourth blocking angle. In this case, the third blocking angle may be set so that an irradiation angle in the upward direction (the y direction) of light irradiated toward the lower surface of the upper door 520-1 is greater than the third blocking angle, and the fourth blocking angle may be set so that an incident angle in the downward direction (the −y direction) of light irradiated toward the upper surface of the lower door 520-2 is greater than the fourth blocking angle. Light having an irradiation angle between the third blocking angle in the upward direction and the fourth blocking angle in the downward direction may not be blocked regardless of an irradiation angle in the horizontal direction (the x direction or the −x direction). The third blocking angle may be greater than the first blocking angle. The fourth blocking angle may be greater than the second blocking angle.

Meanwhile, the second distance measuring apparatus 200-2 may be arranged below the lower door 520-2 and adjacent to the floor. In this case, the second distance measuring apparatus 200-2 may easily detect a foot or a lower body of a person approaching the refrigerator 500. The second distance measuring apparatus 200-2 may be arranged at the rear (the −z direction), relative to the front (the z direction) surface, of the lower door 520-2. In this case, in order to prevent light reflected by the lower surface of the lower door 520-2 or the floor from being incident on a light receiving unit of the second distance measuring apparatus 200-2, a light receiving opening portion of the sensor cover may be provided so that a FoV of the light receiving unit is limited to a certain range. In an embodiment of the disclosure, the light receiving opening portion of the second distance measuring apparatus 200-2 may be provided to pass light having an incident angle in the upward direction (the y direction) that is less than a fifth blocking angle, block light having an incident angle in the upward direction that is equal to or greater than the fifth blocking angle, pass light having an incident angle in the downward direction (the −y direction) that is less than a sixth blocking angle, and block an incident angle in the downward direction that is equal to or greater than the sixth blocking angle. In this case, the fifth blocking angle may be set so that an incident angle in the upward direction (the y direction) of light reflected by the lower surface of the lower door 520-2 and directed toward the light receiving unit of the second distance measuring apparatus 200-2 is greater than the fifth blocking angle, and the sixth blocking angle may be set so that an incident angle in the downward direction (the −y direction) of light reflected by the floor and directed toward the light receiving unit of the second distance measuring apparatus 200-2 is greater than the sixth blocking angle. For example, the FoV of the light receiving unit may be limited to about 2.5 degrees in the upward direction and about 0 degrees in the downward direction, as shown in FIG. 5B.

In addition, in order to prevent a portion of light irradiated to the FoV of the light emitting unit of the second distance measuring apparatus 200-2 from being reflected by the lower surface of the lower door 520-2 or the floor, a light emitting opening portion of the sensor cover may be limited so that the FoV of the light emitting unit of the second distance measuring apparatus 200-2 is limited to a certain range. In an embodiment of the disclosure, a light emitting opening portion of the second distance measuring apparatus 200-2 may be provided to pass light having an irradiation angle in the upward direction (the y direction) that is less than a seventh blocking angle, block light having an irradiation angle in the upward direction that is equal to or greater than the seventh blocking angle, pass light having an irradiation angle in the downward direction (the −y direction) that is less than an eighth blocking angle, and block light having an irradiation angle in the downward direction that is equal to or greater than the eighth blocking angle. In this case, the seventh blocking angle may be set so that an incident angle in the upward direction (the y direction) of light irradiated toward the lower surface of the lower door 520-2 is greater than the seventh blocking angle, and the eighth blocking angle may be set so that an irradiation angle in the downward direction (the −y direction) of light irradiated toward the floor is greater than the eighth blocking angle. The seventh blocking angle may be greater than the fifth blocking angle. The eighth blocking angle may be greater than the sixth blocking angle.

FIG. 5C is a front view and a plan view of a refrigerator 500 including a distance measuring apparatus 200 according to an embodiment of the disclosure. In the embodiment of FIG. 5C, the distance measuring apparatus 200 is attached in a different direction from that of the embodiments of FIGS. 5A and 5B, and the x and y axes are indicated in a different manner from those of FIGS. 5A and 5B for better understanding. In FIG. 5C, the z direction is the front direction of the refrigerator 500, and the y direction is the right direction of the refrigerator 500, and the x direction is the upward direction of the refrigerator 500. With respect to the distance measuring apparatus 200, the y direction may be the upper direction of the distance measuring apparatus 200, and the x direction may be the left direction of the distance measuring apparatus 200.

Referring to FIG. 5C, a body 510 of the refrigerator 500 may include a right door 520-3 and a left door 520-4, and the distance measuring apparatus 200 may be arranged between the right door 520-3 and the left door 520-4. The right door 520-3 and the left door 520-4 may be rotary doors. In particular, the distance measuring apparatus 200 may be arranged in the vicinity of the door handle to easily detect a hand of a person that approaches the door handle to open the door. The distance measuring apparatus 200 may be arranged at the same position in the x direction as the door handle. The distance measuring apparatus 200 may be arranged at a position overlapping the door handle in the x direction. The distance measuring apparatus 200 may be arranged at a position adjacent to the door handle in the x direction. The distance measuring apparatus 200 may be arranged at a rear (the −z direction), relative to the front (the z direction) surface, of the upper door 520-3 or the left door 520-4.

In FIG. 5C, unlike in FIGS. 5A and 5B, the distance measuring apparatus 200 is attached to the refrigerator 500 such that the upper direction (the y direction) of the distance measuring apparatus 200 faces the right direction of the refrigerator 500. Because the embodiment of FIG. 5C is similar to the embodiment of FIGS. 5A and 5B, except that a direction of the distance measuring apparatus 200 is rotated by 90 degrees as described above, what has been described above with reference to FIGS. 5A and 5B may be applied, mutatis mutandis, to the embodiment of FIG. 5C.

FIG. 5D is a front view, a side view, and a plan view of a refrigerator 500 including a distance measuring apparatus 200 according to an embodiment of the disclosure. In the embodiment of FIG. 5D, the distance measuring apparatus 200 is attached in the same direction as in the embodiment of FIG. 5C. Unlike the distance measuring apparatus 200 attached to the body 510 in the embodiment of FIG. 5C, in the embodiment of FIG. 5D, the distance measuring apparatus 200 may be attached to a door 520-5. The door 520-5 may be a rotary door.

The distance measuring apparatus 200 may be attached to a side of the handle of the door 520-5. The distance measuring apparatus 200 may be attached to a side of the door 520-5 in a first direction, which may include a direction from a center of the door 520-5 toward the door handle. The first direction may be the y direction. The distance measuring apparatus 200 may be arranged at the same position in the x direction as the door handle. The distance measuring apparatus 200 may be arranged at a position overlapping the door handle in the x direction. The distance measuring apparatus 200 may be arranged at a position adjacent to the door handle in the x direction. The distance measuring apparatus 200 may be arranged at a rear (the −z direction), relative to the front (the z direction) surface, of the door 520-5. What has been described above with reference to FIGS. 5A, 5B, and 5C may be applied, mutatis mutandis, to the embodiment of FIG. 5D.

The refrigerator 500 according to an embodiment of the disclosure may include a body 510 and at least one distance measuring apparatus 200 attached to the body 510, and the body 510 may include at least one door 520, 520-5 arranged at the front of the refrigerator 500. In this case, the distance measuring apparatus 200 may be arranged so that a front of the distance measuring apparatus 200 faces the front of the refrigerator 500. The distance measuring apparatus 200 may be arranged so that the front of the distance measuring apparatus 200 approximately faces the front of the refrigerator 500. The distance measuring apparatus 200 may be arranged so that the front of the distance measuring apparatus 200 faces a direction within a certain angle (e.g., 45 degrees) from the front of the refrigerator 500.

The light receiving opening portion 212 of the distance measuring apparatus 200 may be provided to block light that is reflected by the body 510 of the refrigerator 500 and incident to the FoV of the light receiving unit 120 from among light incident to the FoV of the light receiving unit 120. The light receiving opening portion 212 of the distance measuring apparatus 200 may be provided to block light that is reflected by the floor where the refrigerator 500 is placed, and incident to the FoV of the light receiving unit 120 from among light incident to the FoV of the light receiving unit 120.

The light emitting opening portion 211 of the distance measuring apparatus 200 may be provided to block light irradiated toward the body 510 of the refrigerator 500 from among light irradiated to the FoV of the light emitting unit 110. The light emitting opening portion 211 of the distance measuring apparatus 200 may be provided to block light irradiated toward the floor on which the refrigerator 500 is placed from among the light irradiated to the FoV of the light emitting unit 110.

The at least one door 520, 520-5 may include a first door, and the distance measuring apparatus 200 may be arranged at a rear relative to a front surface (a surface facing the front of the refrigerator 500) of the first door in a first direction of the first door, and the first direction may be perpendicular to the front of the refrigerator 500. The first direction may be the upper direction, the lower direction, the left direction, or the right direction of the refrigerator 500.

The light receiving opening portion 212 of the distance measuring apparatus 200 may be provided to pass light having an incident angle in a second direction that is less than the first blocking angle, the second direction being an opposite direction of the first direction, and block light having an incident angle in the second direction that is equal to or greater than the first blocking angle. In this case, the first blocking angle may be set so that an incident angle in the second direction of light reflected by a surface in the first direction of the first door and directed toward the light receiving unit 120 of the distance measuring apparatus 200 is greater than the first blocking angle. In other words, the first blocking angle may be less than an incident angle in the second direction of light reflected by the surface in the first direction of the first door and directed toward the light receiving unit 120 of the distance measuring apparatus 200.

The at least one door 520, 520-5 may further include a second door arranged in the first direction of the first door, at the front of the refrigerator 500, and the distance measuring apparatus 200 may be arranged between the first door and the second door at a rear relative to a front surface of the second door. The first door and the second door may be an upper door and a lower door, respectively. The first door and the second door may be a right door and a left door, respectively.

The light receiving opening portion 212 of the distance measuring apparatus 200 may be provided to pass light having an incident angle in the first direction that is less than the second blocking angle and block light having an incident angle in the first direction that is equal to or greater than the second blocking angle. The second blocking angle may be less than an incident angle in the first direction of light reflected by a surface in a second direction of the second door and directed toward the light receiving unit 120.

The distance measuring apparatus 200 may be arranged adjacent to the floor on which the refrigerator 500 is placed. The first direction may be the lower direction of the refrigerator 500, and the first door may be arranged so that a lower surface of the first door is adjacent to the floor on which the refrigerator 500 is placed. The distance measuring apparatus 200 may be arranged between the first door and the floor.

The light receiving opening portion 212 of the distance measuring apparatus 200 may be provided to pass light having an incident angle in the downward direction that is less than the third blocking angle and block light having an incident angle in the downward direction that is greater than the third blocking angle. The third blocking angle may be less than an incident angle in the downward direction of light reflected by the floor and directed toward the light receiving unit 120.

An electronic apparatus according to an embodiment of the disclosure may include the distance measuring apparatus 200, and the light emitting opening portion 211 of the distance measuring apparatus 200 may be provided to block light irradiated toward a body of the electronic apparatus from among light irradiated to a FoV of the light emitting unit 110. The light emitting opening portion 211 may be provided to block light irradiated toward the floor on which the electronic apparatus is placed from among light irradiated to the FoV of the light emitting unit 110. In addition, the light receiving opening portion 212 of the distance measuring apparatus 200 may be provided to block light reflected by the body of the electronic apparatus and incident to the FoV of the light receiving unit 120 from among light incident to the FoV of the light receiving unit 120. The light receiving opening portion 212 may be provided to block light reflected by the floor and incident to the FoV of the light receiving unit 120 from among light incident to the FoV of the light receiving unit 120.

In an embodiment of the disclosure, the light emitting opening portion 211 may be provided to be larger than the light receiving opening portion 212 so that more light is reflected and thereby, a sensitivity of the distance measuring apparatus 200 is increased. FIG. 6 is an experiment result of the performances of distance measuring apparatuses according to embodiments of the disclosure. In the table of FIG. 6, count represents a return ambient rate of a distance sensor in mega-counts per second (MCPS) expressed as a 16.16 fixed point value, and it may be seen that the higher the count value, the higher the sensitivity of the distance measuring apparatus. Referring to FIG. 6, in the distance measuring apparatus 200, compared to when the vertical width of the light emitting opening portion 211 is equal to the vertical width of the light receiving opening portion 212, when a vertical width of the light emitting opening portion 211 is greater than a vertical width of the light receiving opening portion 212, the count value is higher, and thus, the sensitivity of the distance measuring apparatus may be increased. A detection area of the distance measuring apparatus may be determined to be similar to the FoV of the light receiving unit, but when the light emitting opening portion 211 is enlarged, the detection area of the distance measuring apparatus may be slightly widened.

In an embodiment of the disclosure, a width in the y direction of the light emitting opening portion 211 may be greater than a width in the y direction of the light receiving opening portion 212. In an embodiment of the disclosure, a width in the x direction of the light emitting opening portion 211 may be equal to a width in the x direction of the light receiving opening portion 212. In an embodiment of the disclosure, a horizontal width of the light emitting opening portion 211 may be equal to a horizontal width of the light receiving opening portion 212, and a vertical width of the light emitting opening portion 211 may be greater than a vertical width of the light receiving opening portion 212. Here, being equal may include being substantially equal. The y direction is perpendicular to the front direction (the z direction) of the distance measuring apparatus. When the distance measuring apparatus is attached to detect the front of the electronic apparatus (e.g., a refrigerator), the y direction may be perpendicular to the front of the electronic apparatus.

In an embodiment of the disclosure, the light receiving opening portion 212 may be provided to pass light having an incident angle in a first direction that is less than the first blocking angle and block light having an incident angle in the first direction that is equal to or greater than the first blocking angle. The first direction may be perpendicular to the front direction (the z direction) of the distance measuring apparatus. The first direction may be perpendicular to the front direction of the electronic apparatus (e.g., a refrigerator) to which the distance measuring apparatus is attached. The light emitting opening portion 211 may be provided to pass light having an irradiation angle in the first direction that is less than the second blocking angle and block light having an irradiation angle in the first direction that is equal to or greater than the second blocking angle, and the second blocking angle may be greater than the first blocking angle.

In an embodiment of the disclosure, in order to maximize the sensitivity of the distance measuring apparatus 200, the light emitting unit 110 may be completely opened, and the sensor cover 210 may cover only the vicinity of the light receiving unit 120.

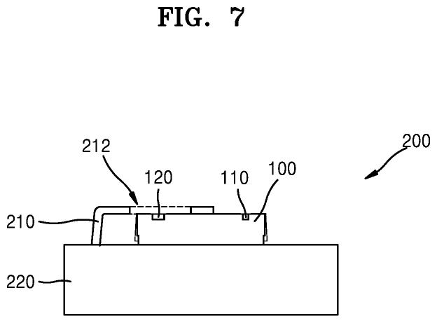

FIG. 7 is a diagram schematically illustrating a configuration of a distance measuring apparatus 200 according to an embodiment of the disclosure. Referring to FIG. 7, the distance measuring apparatus 200 according to an embodiment of the disclosure may include a distance sensor 100 and a sensor cover 210. The distance sensor 100 includes a light emitting unit 110 configured to irradiate light at a certain FoV and a light receiving unit 120 configured to receive light incident to a certain FoV. The sensor cover 210 includes a light receiving opening portion 212 that is provided to pass a portion of light incident to the FoV of the light receiving unit 120 and block a remaining portion of light incident to the FoV of the light receiving unit 120. In this case, the FoV of the light emitting unit 110 may not be limited at all. Compared to the embodiment of FIG. 7, in the embodiment of FIG. 2, the detection area, accuracy, sensitivity, etc. of the distance measuring apparatus 200 may be more precisely designed by appropriately limiting the FoV of the light emitting unit 110. According to the embodiment of FIG. 2, as described above, light irradiated from the light emitting unit 110 may be prevented from being reflected by the body of the electronic apparatus or the floor.

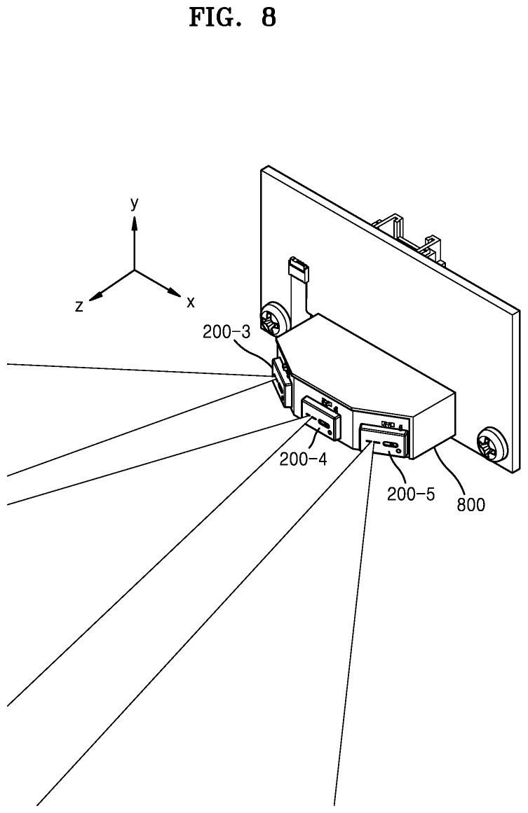

The light emitting opening portion 211 being larger than the light receiving opening portion 212 as shown in FIG. 6 and the sensor cover 210 not covering the light emitting opening portion 211 as shown in FIG. 7 may be applied to all of the embodiments of the disclosure, including the embodiment of FIGS. 5A to 5C and the embodiments of FIGS. 8 to 10.

Hereinabove, a method for limiting a detection area of the distance measuring apparatus 200 by using the sensor cover 210 is described. However, the detection area may be extended using a plurality of distance measuring apparatuses 200.

FIG. 8 is a diagram illustrating a distance measuring module 800 including a plurality of distance measuring apparatuses 200-3, 200-4, and 200-5 and detection areas of the plurality of distance measuring apparatuses 200-3, 200-4, and 200-5 according to an embodiment of the disclosure. Referring to FIG. 8, the distance measuring module 800 according to an embodiment of the disclosure may include the plurality of distance measuring apparatuses 200-3, 200-4, and 200-5. In FIG. 8, the z direction may be a direction to which a detection area of the distance measuring module 800, the distance measuring module 800 including detection areas of the plurality of distance measuring apparatuses 200-3, 200-4, and 200-5 is directed, and may be referred to as a front direction of the distance measuring module 800. The z direction may be a front direction of any of the plurality of distance measuring apparatuses 200-3, 200-4, and 200-5, for example, the distance measuring apparatus 200-4 in the center. In an embodiment of the disclosure, when the distance measuring module 800 is attached toward the front direction of the refrigerator 500 to detect the front direction of the refrigerator 500, the z direction may be the front direction of the refrigerator 500 or a direction within a certain angle (e.g., 45 degrees) from the front direction of the refrigerator 500.

The plurality of distance measuring apparatuses 200-3, 200-4, and 200-5 may be arranged in a line close to each other in the x direction. Here, being arranged in a line does not necessarily mean being arranged on a straight line, and may include being arranged on a curved line that is not perpendicular to the x direction. The x direction may be a direction perpendicular to a front direction of any of the plurality of distance measuring apparatuses 200-3, 200-4, and 200-5.

The plurality of distance measuring apparatuses 200-3, 200-4, and 200-5 may be arranged to have a certain angular difference on an x-z plane so that a FoV of each of light receiving units of the plurality of distance measuring apparatuses 200-3, 200-4, and 200-5 is radially widened on the x-z plane, and thereby, the detection area of the distance measuring module 800 may be extended in the x direction. In this case, the FoV of each of the light receiving units of the plurality of distance measuring apparatuses 200-3, 200-4, and 200-5 may be arranged to widen without overlapping each other.

Hereinafter, that the FoVs of the light receiving units are radially widened so that the detection area of the distance measuring module 800 is extended in the first direction (the x direction) that is perpendicular to the front direction (the z direction) is expressed that the FoVs of the light receiving units are radially widened in the first direction (the x direction), and an angular difference between the plurality of distance measuring apparatuses 200-3, 200-4, and 200-5 for allowing the FoVs of the light emitting units to be radially widened in the first direction (the x direction) is expressed as an angular difference in the first direction (the x direction). That FoVs of light emitting units or the detection areas are radially widened may be expressed the same.

The plurality of distance measuring apparatuses 200-3, 200-4, and 200-5 may be arranged to have a certain angular difference in the x direction so that the detection areas thereof are radially widened in the x direction, and thereby, the detection area of the distance measuring module 800 may be extended in the x direction. In this case, the detection areas of the plurality of distance measuring apparatuses 200-3, 200-4, 200-5 may be widened without overlapping each other. In the embodiment of FIG. 8, three distance measuring apparatuses 200-3, 200-4, and 200-5 are used, but two or four or more distance measuring apparatuses may be used.

A refrigerator 500 according to an embodiment of the disclosure may include a body 510 and a plurality of distance measuring apparatuses 200 attached to the body 510, and the body of the refrigerator may include at least one door 520 at the front of the refrigerator 500. A light receiving opening portion of each of the plurality of distance measuring apparatuses may be provided to pass light having an incident angle in the first direction (the y direction) that is less than the first blocking angle and block light having an incident angle in the first direction that is equal to or greater than the first blocking angle, and the first direction may be perpendicular to the front direction of the refrigerator 500.

The plurality of distance measuring apparatuses may be arranged in a second direction (the x direction) that is perpendicular to the first direction, and may have a certain angular difference in the second direction so that FoVs of light receiving units of the plurality of distance measuring apparatuses are radially widened without overlapping each other in the second direction. The second direction may be perpendicular to the front direction of the refrigerator.

The plurality of distance measuring apparatuses may be arranged in the second direction, and may have a certain angular difference in the second direction so that the detection areas of the plurality of distance measuring apparatuses are radially widened without overlapping each other in the second direction.

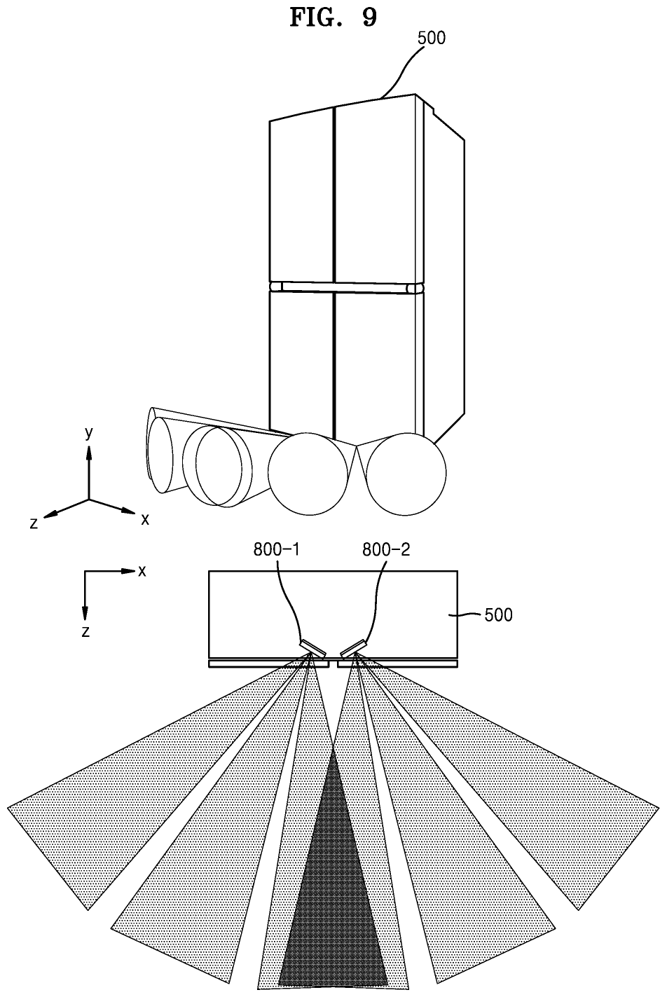

FIG. 9 is a diagram illustrating a refrigerator 500 including a plurality of distance measuring modules 800-1 and 800-2 and detection areas thereof according to an embodiment of the disclosure. Referring to FIG. 9, the refrigerator 500 according to an embodiment of the disclosure may include the plurality of distance measuring modules 800-1 and 800-2. In FIG. 9, the z direction is a front direction of the refrigerator 500. A front direction of each of the distance measuring modules 800-1 and 800-2 may include the front direction of the refrigerator 500 or a direction within a certain angle (e.g., 45 degrees) from the front of the refrigerator 500. A front direction of each of the plurality of distance measuring apparatuses included in the distance measuring modules 800-1 and 800-2 may include the front direction of the refrigerator 500 or a direction within a certain angle (e.g., 45 degrees) from the front direction of the refrigerator 500. A front direction of at least one of the plurality of distance measuring apparatuses included in each of the distance measuring modules 800-1 and 800-2 may be the front direction of the refrigerator 500.

The plurality of distance measuring modules 800-1 and 800-2 may be arranged in a line to be apart from each other in the x direction. Here, being arranged in a line does not necessary mean being arranged in a straight line. The x direction may be a direction in which the distance measuring apparatuses included in each of the plurality of distance measuring modules 800-1 and 800-2 are arranged.

The plurality of distance measuring modules 800-1 and 800-2 may be arranged to have a certain angular difference on an x-z plane so that FoVs of the distance measuring apparatuses included in the distance measuring modules 800-1 and 800-2 are widened in the x direction. Here, the x direction may be a direction in which the distance measuring apparatuses included in the distance measuring modules 800-1 and 800-2 are arranged. The x direction may include the upper direction, the lower direction, the left direction, or the right direction of the refrigerator 500.

The plurality of distance measuring modules 800-1 and 800-2 may be arranged to have a certain angular difference on the x-z plane so that the detection areas of the distance measuring modules 800-1 and 800-2 are widened in the x direction. The detection areas may partially overlap each other as necessary, as in the embodiment of FIG. 9.

A refrigerator 500 according to an embodiment of the disclosure may include a body 510 and a plurality of distance measuring apparatuses attached to the body 510, and the body 510 of the refrigerator 500 may include at least one door 520 at the front of the refrigerator 500. A light receiving opening portion of each of the plurality of distance measuring apparatuses may be provided to pass light having an incident angle in the first direction that is less than the first blocking angle and block light having an incident angle in the first direction that is equal to or greater than the first blocking angle. Here, the first direction may be perpendicular to the front direction of the refrigerator.

The light receiving opening portion of each of the plurality of distance measuring apparatuses may be provided to pass light having an incident angle in the first direction that is less than the first blocking angle and block light having an incident angle in the first direction that is equal to or greater than the first blocking angle.

The refrigerator 500 may include a first distance measuring module and a second distance measuring module, the first distance measuring module including two or more of the plurality of distance measuring apparatuses, and the second distance measuring module including other two or more of the plurality of distance measuring apparatuses. The distance measuring apparatuses included in the first distance measuring module may be arranged in a second direction perpendicular to the first direction, and may have a certain angular difference in the second direction so that the detection areas of the distance measuring apparatuses are radially widened without overlapping each other in the second direction. The distance measuring apparatuses included in the second distance measuring module may be arranged in the second direction, and may have a certain angular difference in the second direction so that the detection areas of the distance measuring apparatuses are radially widened without overlapping each other in the second direction. The second distance measuring module may be arranged in the second direction of the first distance measuring module to be apart from the first distance measuring module in the second direction.

Here, the first direction and the second direction may be perpendicular to the front direction (the z direction) of the refrigerator 500. The first direction may be the upward direction (the y direction) or the downward direction (the −y direction) of the refrigerator 500, and the second direction may be the left direction (the x direction) or the right direction (the −x direction) of the refrigerator 500. The first direction may be the left direction (the x direction) or the right direction (the −x direction) of the refrigerator 500, and the second direction may be the upward direction (the y direction) or the downward direction (the −y direction) of the refrigerator.

The plurality of distance measuring apparatuses may be arranged adjacent to the floor on which the refrigerator 500 is placed. The first distance measuring module and the second distance measuring module may be arranged adjacent to the floor, and the second direction may be a direction parallel to the floor.

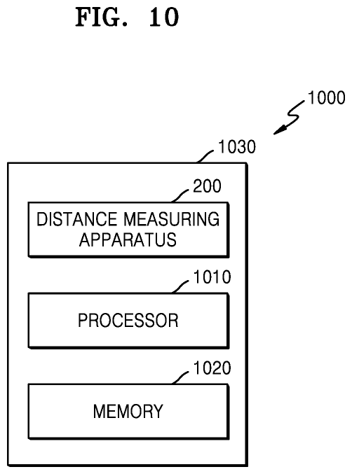

FIG. 10 is a block diagram of a configuration of an electronic apparatus 1000 according to an embodiment of the disclosure. Referring to FIG. 10, the electronic apparatus 1000 according to an embodiment of the disclosure may include a body 1030, a distance measuring apparatus 200 provided on the body 1030, at least one processor 1010, and at least one memory 1020 storing one or more instructions that may be executed by the at least one processor 1010.

The processor 1010 of the electronic apparatus 1000 may execute the instructions stored in the memory 1020 to thereby perform different operations by step according to a distance to a detected target object. For example, based on a determination result of the distance measuring apparatus 200, the electronic apparatus 1000 may turn on a welcome light of the electronic apparatus 1000 based on determining that an object has approached within a first distance, and open a door of the electronic apparatus 1000 based on determining that the object has approached within a second distance that is less than the first distance. The electronic apparatus 1000 may open the door only when there is a voice command by a user. For example, the electronic apparatus 1000 may open the door based on an input of a voice command of the user to open the door and a determination that an object is within the second distance.

The electronic apparatus 1000 may not open the door when a target object (a person) is too close. For example, based on determining, based on a detection result of the distance measuring apparatus 200, that an object is within the second distance and the object is not within a third distance that is less than the second distance, the electronic apparatus 1000 may open the door. The embodiment described above may protect the user especially when the door of the electronic apparatus 1000 is a rotary door, and thus is useful.

The electronic apparatus 1000 may automatically close the door when a certain condition is satisfied. For example, the electronic apparatus 1000 may close the door when a certain time has elapsed after the door is opened or when a voice command of the user to close the door is input.

However, even when a certain condition for closing the door is satisfied, the electronic apparatus 1000 may not close the door when a person is too close. In an embodiment of the disclosure, when a certain door closing condition is satisfied, the electronic apparatus 1000 may close the door based on determining that an object is not within the third distance based on a detection result of the distance measuring apparatus 200. When a time has elapsed from when the door is opened, the electronic apparatus 1000 may close the door based on determining that an object is not within the third distance based on a detection result of the distance measuring apparatus 200. When a voice command of the user to close the door is input, the electronic apparatus 1000 may close the door based on determining that an object is not within the third distance based on a detection result of the distance measuring apparatus 200. The embodiment described above may protect the user especially when the door of the electronic apparatus 1000 is a rotary door, and thus is useful.

In an embodiment of the disclosure, the electronic apparatus 1000 may, when a fixed object is within a detection range thereof, exclude the object in distance detection. For example, when a target object is detected by one of the plurality of distance measuring apparatuses 200 provided in the electronic apparatus 1000, and the corresponding target object remains motionless for a long period of time (a certain period of time), the electronic apparatus 1000 may exclude the target object from a target to be detected, and determine that the object is within the detection range only when the corresponding distance measuring apparatus detects an object that is closer to the electronic apparatus 1000 than the target object. When a distance of a target object is measured by one of the plurality of distance measuring apparatuses 200 included in the electronic apparatus 1000, and a distance measurement value of the corresponding distance measuring apparatus remains unchanged for a long period of time (a certain period of time), the distance measurement value may be excluded, and it may be determined that the distance of the target object is measured, only when the corresponding distance measurement apparatus measures a distance less than the distance measurement value. The electronic apparatus 1000 according to an embodiment of the disclosure may determine whether an object within the detection range of the distance measuring apparatus 200 is a fixed object based on a detection result of the distance measuring apparatus 200, and based on determining that the corresponding object is a fixed object, ignore the corresponding object in future distance detection.

An operation method of the electronic apparatus 1000 according to an embodiment of the disclosure may include an operation of turning on a welcome light of the electronic apparatus 1000 based on determining, based on a detection result of the distance measuring apparatus 200, that an object is within the first distance, and an operation of opening the door of the electronic apparatus 1000 based on determining that an object is within a second distance that is less than the first distance.

The operation method of the electronic apparatus 1000 according to an embodiment of the disclosure may include an operation of opening the door of the electronic apparatus 1000 based on determining, based on a detection result of the distance measuring apparatus 200, that an object is within the second distance, and based on determining that an object is not within a third distance that is less than the second distance.

The operation method of the electronic apparatus 1000 according to an embodiment of the disclosure may include an operation of, when a certain period of time has elapsed after the door is opened or when a voice command of the user to close the door is input, closing the door based on determining that an object is not within the third distance based on a detection result of the distance measuring apparatus 200.

The operation method of the electronic apparatus 1000 according to an embodiment of the disclosure may include an operation of determining whether an object within the detection range of the distance measuring apparatus 200 is a fixed object based on a detection result of the distance measuring apparatus 200, and an operation of, based on determining that the corresponding object is a fixed object, ignoring the corresponding object in future distance detection.

All features and/or operations of the disclosure, including in the claims and drawings, may be combined in any combination unless at least some of the features and/or operations contradict each other.

Embodiments of the disclosure may be provided as a computer-executable program product, and the program may be stored in a computer-readable recording medium. Examples of the computer-readable recording medium include all recording media such as a magnetic medium, an optical medium, read-only memory (ROM), and random-access memory (RAM). The computer-readable recording medium may be provided in the form of a non-transitory storage medium. Here, the “non-transitory storage medium” is a tangible apparatus, and only means that it does not include a signal (e.g., an electromagnetic wave), and this term does not distinguish between a case in which data is semi-permanently stored in a storage medium and a case in which data is temporarily stored. For example, the “non-transitory storage medium” may include a buffer in which data is temporarily stored.

According to an embodiment, the method according to various embodiments of the disclosure may be provided in a computer program product. The computer program product may be a commercial product that may be traded between a seller and a buyer. The computer program product may be stored and distributed in a computer-readable recording medium, or may be distributed (e.g., downloaded or uploaded) online through an application store (e.g., Play Store™) or directly between two user apparatuses (e.g., smartphones). In the case of online distribution, at least a part of the computer program product (e.g., a downloadable app) may be temporarily stored or temporarily generated in a computer-readable recording medium such as a memory of a server of a manufacturer, a server of an application store, or a relay server.

While the disclosure has been particularly shown and described with reference to embodiments thereof, the embodiments are non-limiting examples of the disclosure, and should be considered in a descriptive sense only and not for purposes of limitation. It will be understood by one of ordinary skill in the art that the embodiments may be easily modified in other specific forms all without changing the technical spirit or the essential features of the disclosure. For example, each component described as a single type may be executed in a distributed manner, and components described as a distributed type may be executed in a combined type. While the disclosure has been described by using specific terms, the terms have merely been used to explain the disclosure and should not be construed as limiting the concept or scope of the disclosure as defined by the claims.

The scope of the disclosure is indicated by the claims rather than by the detailed description of the disclosure, and it should be understood that the claims and all modifications or modified forms drawn from the concept and scope of the claims and equivalents are included in the scope of the disclosure. Additionally, it is intended that such equivalents include both currently known equivalents and equivalents to be developed in the future, i.e., any elements developed to perform the same function, regardless of structure.

What is claimed is:

1. A refrigerator comprising:
a body including at least one door at a front of the refrigerator; and
at least one distance measuring apparatus attachable to the body,
wherein the at least one distance measuring apparatus comprises:
a distance sensor comprising a light emitting unit and a light receiving unit, the light emitting unit being configured to irradiate light along a first field of view (FoV), and the light receiving unit being configured to receive light incident on a second FoV; and
a sensor cover comprising a light receiving opening portion, the light receiving opening portion being provided to pass a portion of light incident on the second FoV and block a remaining portion of the light incident on the second FoV.

2. The refrigerator of claim 1, wherein the light receiving opening portion is provided to block light reflected by the body and incident from among the light incident on the second FoV.

3. The refrigerator of claim 1, wherein the light receiving opening portion is provided to block light reflected by a floor where the refrigerator is placed and incident on the second FoV.

4. The refrigerator of claim 1, wherein the at least one distance measuring apparatus is arranged along a first direction of the at least one door, at a rear of a front surface of the at least one door,
the first direction is perpendicular to the front of the refrigerator,
the light receiving opening portion is provided to pass light with an incident angle in a second direction opposite to the first direction that is less than a first blocking angle and block light with an incident angle in the second direction that is equal to or greater than the first blocking angle, and
the first blocking angle is less than an incident angle along the second direction of light reflected by a surface of the at least one door in the first direction and directed toward the light receiving unit.

5. The refrigerator of claim 4, wherein the at least one distance measuring apparatus is attached to a side of the at least one door in the first direction, and
the first direction is along a direction from a center of the at least one door toward a handle of the at least one door.

6. The refrigerator of claim 4, wherein the at least one door is a first door and the refrigerator further comprises a second door arranged along the first direction of the first door,
the at least one distance measuring apparatus is arranged between the first door and the second door, at a rear of a front surface of the second door,
the light receiving opening portion is provided to pass light with an incident angle in the first direction that is less than a second blocking angle and block light with an incident angle in the first direction that is equal to or greater than the second blocking angle, and
the second blocking angle is less than an incident angle in the first direction of light reflected by a surface in the second direction of the second door and directed toward the light receiving unit.

7. The refrigerator of claim 4, wherein the first direction is along a downward direction of the refrigerator,
the at least one door is arranged so that a lower surface of the at least one door is adjacent to a floor on which the refrigerator is placed,
the light receiving opening portion is provided to pass light with an incident angle in the downward direction that is less than a third blocking angle and block light with an incident angle in the downward direction that is equal to or greater than the third blocking angle, and
an incident angle along the downward direction of light reflected by the floor and directed toward the light receiving unit is greater than the third blocking angle.

8. The refrigerator of claim 1, wherein the at least one distance measuring apparatus is arranged adjacent to a floor on which the refrigerator is placed,
the light receiving opening portion is provided to pass light with an incident angle along a downward direction that is less than a third blocking angle and block light with an incident angle along the downward direction that is equal to or greater than the third blocking angle, and
the third blocking angle is less than an incident angle along the downward direction of light reflected by the floor and directed toward the light receiving unit.

9. The refrigerator of claim 1, wherein the sensor cover comprises a light emitting opening portion configured to pass a portion of light irradiated from the light emitting unit to the first FoV and block a remaining portion of light irradiated from the light emitting unit to the first FoV.

10. The refrigerator of claim 9, wherein the sensor cover is configured such that a portion of the sensor cover is adjacent one surface of the distance sensor, so that the light irradiated from the light emitting unit to the first FoV is not incident on the light receiving unit by being reflected by the sensor cover.

11. The refrigerator of claim 9, wherein the light emitting opening portion is provided to block light irradiated toward the body or a floor on which the refrigerator is placed from among the light irradiated to the first FoV.

12. The refrigerator of claim 9, wherein a width of the light emitting opening portion along a first direction is greater than a width of the light receiving opening portion along the first direction, and
the first direction which is perpendicular to the front of the refrigerator.

13. The refrigerator of claim 9, wherein the light receiving opening portion is provided to pass light with an incident angle along the first direction that is less than a first blocking angle and block light with an incident angle along the first direction that is greater than the first blocking angle,
the first direction is perpendicular to the front of the refrigerator,
the light emitting opening portion is provided to pass light with an irradiation angle along the first direction that is less than a second blocking angle and block light with an irradiation angle along the first direction that is equal to or greater than the second blocking angle, and
the second blocking angle is greater than the first blocking angle.

14. The refrigerator of claim 1, wherein the at least one distance measuring apparatus is among a plurality of distance measuring apparatuses,
a light receiving opening portion of each of the plurality of distance measuring apparatuses is provided to pass light with an incident angle along a first direction that is less than a first blocking angle and block light with an incident angle along the first direction that is equal to or greater than the first blocking angle,
the plurality of distance measuring apparatuses are arranged along a second direction perpendicular to the first direction, and are arranged to have a certain angular difference so that detection areas of the plurality of distance measuring apparatuses are radially widened without overlapping each other along the second direction, and
the first direction and the second direction are perpendicular to the front of the refrigerator.

15. The refrigerator of claim 1, wherein the at least one distance measuring apparatus is among a plurality of distance measuring apparatuses,
a light receiving opening portion of each of the plurality of distance measuring apparatuses is provided to pass light with an incident angle along a first direction that is less than a first blocking angle and block light with an incident angle in the first direction that is equal to or greater than the first blocking angle,
the refrigerator comprises a first distance measuring module and a second distance measuring module, the first distance measuring module comprising two or more of the plurality of distance measuring apparatuses, and the second distance measuring module comprising another two or more of the plurality of distance measuring apparatuses,
the two or more of the plurality of distance measuring apparatuses included in the first distance measuring module are arranged along a second direction perpendicular to the first direction, and are arranged to have a certain angular difference so that detection areas are radially widened without overlapping each other along the second direction,
the other two or more of the plurality of distance measuring apparatuses included in the second distance measuring module are arranged along the second direction, and are arranged to have a certain angular difference so that detection areas are radially widened without overlapping each other in the second direction,
the second distance measuring module are arranged along the second direction of the first distance measuring module to be apart from the first distance measuring module in the second direction, and
the first direction and the second direction are perpendicular to the front of the refrigerator.

16. An electronic apparatus comprising:
a memory to store one or more instructions;
a processor configured to execute the one or more instructions;
a body; and
at least one distance measuring apparatus attachable to the body,
wherein the at least one distance measuring apparatus comprises:
a distance sensor comprising a light emitting unit and a light receiving unit, the light emitting unit being configured to irradiate light along a first field of view (FoV), and the light receiving unit being configured to receive light incident on a second FoV; and
a sensor cover comprising a light receiving opening portion, the light receiving opening portion being provided to pass a portion of light incident on the second FoV and block a remaining portion of the light incident on the second FoV.

17. The electronic apparatus of claim 16, wherein the sensor cover comprises a light emitting opening portion provided to pass the portion of light irradiated from the light emitting unit and block the remaining portion of the light irradiated from the light emitting unit.

18. The electronic apparatus of claim 17, wherein a width of the light emitting opening portion along a first direction is greater than a width of the light receiving opening portion along the first direction, and
the first direction is perpendicular to a front of the distance measuring apparatus.

19. The electronic apparatus of claim 17, wherein the light receiving opening portion is provided to pass light with an incident angle along a first direction that is less than a first blocking angle and block light with an incident angle along the first direction that is equal to or greater than the first blocking angle,
the light emitting opening portion is provided to pass light with an irradiation angle along the first direction that is less than a second blocking angle and block light with an irradiation angle along the first direction that is equal to or greater than the second blocking angle,
the first direction is perpendicular to a front of the distance measuring apparatus, and
the second blocking angle is greater than the first blocking angle.

20. The electronic apparatus of claim 17, wherein the sensor cover is configured such that a portion of the sensor cover is adjacent one surface of the distance sensor, so that the light irradiated from the light emitting unit to the first FoV is not incident on the light receiving unit by being reflected by the sensor cover.
